(19) United States
(12) Patent Application Publication
(10) Pub. No.: US 2006/0198975 A1
(43) Pub. Date: Sep. 7, 2006

(54) Laminate material, laminate material manufacturing method, laminate material heat-sealing method, and package container

(75) Inventor: Hideyo Kikuchi, Tokyo (JP)

Correspondence Address: BUCHANAN INGERSOLL PC, POST OFFICE BOX 1404, ALEXANDRIA, VA, 22313-1404, US

(73) Assignee: TETRA LAVAL HOLDINGS & FINANCE S.A., Pully (CH)

(21) Appl. No.: 10/546,819

(22) PCT Filed: Dec. 4, 2003
(86) PCT No.: PCT/JP03/15515

§ 371 Date: Aug. 25, 2005

(30) Foreign Application Priority Data
Feb. 28, 2003 (JP) 2003-53806

(51) Int. Cl. B32B 15/04; B65B 9/00

(52) U.S. Cl. 428/35.8; 428/457; 53/450

(57) ABSTRACT

Even if an aseptic packaging system and a chilled packaging system are installed, a part of the counter system is diverted, thereby enabling efficient operation of the whole packaging systems. Therefore, the energy and materials can be reduced, and the manufacturing cost is also reduced. A laminate material is a web-shaped material for a package container. The laminate material has a support layer (1) and a thermoplastic innermost layer (3). A conductive layer (2) is provided in the region to be heat-sealed by high-frequency induction heating between the support layer (1) and the thermoplastic innermost layer (3) so that the heat generated by the induction heating is conducted to the innermost layer. The conductive layer (2) is a metal vapor deposition layer (2) provided on a base film (9) of a vapor deposition film (8) and made of a metallic conductive material.

### TECHNICAL FIELD

The present invention relates to a laminate material, a laminate material manufacturing method, a laminate material heat-sealing method, and a package container.

### BACKGROUND ART

A web-shaped laminate material for a package container which comprises a support layer and a thermoplastic innermost layer and has a carbon black conductive layer provided in a region to be heat-sealed by high-frequency induction heating for forming the container between the support layer and the thermoplastic innermost layer, is already known, for example, it is described in Japanese Examined Patent Publication (Kokoku) No. 1988-222. A laminate material shown in FIG. 1 comprises a support layer, a thermoplastic innermost layer and a carbon black conductive layer as an interlayer there between. A packaging machine which is equipped with an attaching device to attach an aluminum foil tape for high-frequency induction heating to a region to be heat-sealed in a web-shaped laminate material and heats the aluminum foil tape by high-frequency induction with a high-frequency coil in a heater, and is described for instance in Japanese Patent No. 2694286.

Packaging paper containers for fluid foods are classified into either aseptic packaging systems which is storable at normal temperature or chilled packaging systems distributed under chilled conditions like milk containers. In general, respective packaging laminate materials are separatedly manufactured in an aseptic packaging system or a chilled packaging system, and are filled and packed with fluid foods by the separate packaging and filling machines and by separate sealing methods. However, even if a an aseptic packaging and a chilled packaging are installed, a part of the counter system is diverted, thereby enabling efficient operation of the whole packaging systems and, furthermore, this contributes to the saving of the energy and materials and the reduction of the manufactring cost.

### DISCLOSURE OF THE INVENTION

The present invention takes as its object the provision of a laminate material, a laminate material manufacturing method, a laminate material heat-sealing method, and a package container which solve the problems described above.

The laminate material and the package container of the present invention solving the problems comprises a web-shaped laminate material for a package container comprising a support layer and a thermoplastic innermost layer which has a conductive layer provided in a region to be heat-sealed by high-frequency induction heating for producing the container between the support layer and the thermoplastic innermost layer so that the heat generated by the induction heating is conducted to the innermost layer, wherein the conductive layer is a metal vapor deposition layer made of a metallic conductive material provided on a base film of a vapor deposition film between the support layer and the thermoplastic innermost layer. Consequently, even if an aseptic packaging system and a chilled packaging system are installed, a part of the counter system is diverted, thereby enabling efficient operation of the whole packaging systems, and this further contributes to the resuction of the energy, materials and manufacturing cost.

The invention of the laminate material according to claim 1 of the present invention is characterized in that the web-shaped laminate material for a package container comprising at least a support layer and a thermoplastic innermost layer, has a conductive layer provided in the region to be heat-sealed by high-frequency induction heating for producing the container between the support layer and the thermoplastic innermost layer so that the heat generated by the induction heating is conducted to the innermost layer, wherein the conductive layer is a metal vapor deposition layer made of a metallic conductive material provided on a base film of a vapor deposition film between the support layer and the thermoplastic innermost layer.

In the invention of the laminate material according to claim 2, the above-described conductive layer is a metal vapor deposition layer made of a metallic conductive material provided inside of the base film of the vapor deposition film between the support layer and the thermoplastic innermost layer.

In the invention of the laminate material of claim 3, the above-described conductive layer is a metal vapor deposition layer made of a metallic conductive material provided outside of the base film of the vapor deposition film between the support layer and the thermoplastic innermost layer.

The invention of method for manufacturing the laminate material according to claim 4 is characterized in that the method for manufacturing a web-shaped laminate material for a package container comprising at least a support layer and a thermoplastic innermost layer, comprises: preparing a plurality of rolled materials of the support layer; sequentially drawing a web-shaped support layer from the rolled materials; providing a vapor deposition film comprising a base film and a metal vapor deposition layer of a metallic conductive material provided inside or outside of the base film, inside the support layer including a region to be heat-sealed by high-frequency induction heating for producing the container; printing a design for the container indirectly or directly outside of the lengthy web-shaped support layer; simultaneously or sequentially forming same or different types of, one or a plurality of thermoplastic layers, outside and inside of the printed web-shaped support layer; and jointing the front end of the web-shaped support layer in the upstream with the back end of the web-shaped support layer in the downstream to form a more lengthy web-shaped support layer.

The invention of the heat-sealing method of the laminate material according to claim 5 is characterized in that the method of heat-sealing a laminate material for a package container comprised of at least a support layer and a thermoplastic innermost layer, having a conductive layer provided in a region to be heat-sealed by high-frequency induction heating for producing the container between the support layer and the thermoplastic innermost layer so that the heat generated by the induction heating is conducted to the innermost layer, comprises: preparing a web-shaped laminate material wherein the conductive layer is a metal vapor deposition layer made of a metallic conductive material provided on a base film of a vapor deposition film between the support layer and the thermoplastic innermost layer; shaping the web-shaped laminate material in a tubular shape to longitudinally seal it in the longitudinal direction; filling a fluid food into the tube of the laminate material; forming a heat-seal region across the filled tube by high-frequency induction heating at prescribed intervals to transversely seal it in the transverse direction; and cutting the center of the sealed region to form individual containers.

The invention of the package container of claim 6 is characterized in that the package container made of the laminate material comprising at least a support layer and a thermoplastic innermost layer, has a conductive layer that is a metal vapor deposition layer made of a metallic conductive material provided on a base film of a vapor deposition film between the support layer and the thermoplastic innermost layer in a region heat-sealed by high-frequency induction heating for producing the container, wherein the innermost layer is melted or softened by the heat generated by the induction heating to form a seal region with the opposing softened or melted innermost layer.

This invention with the above constitutions has the following operation. The web-shaped laminate material for a package container of the present invention has lengthy band shape (web shape) capable of forming a number of containers, thereby enabling continuous and rapid filling production of the package container. In the present invention, the support layer gives physical and mechanical strength to the package container and the laminate material, and maintains and supports their shapes, configurations or the like. The thermoplastic innermost layer, which is also the innermost layer of the container wall of the container, directly contacts with a fluid food and prevents the fluid from permeating into the support layer of the container and moistening the same. Additionally, the innermost layer is melted or softened by heating to form a seal region for heat seal.

The conductive layer is a metal vapor deposition layer made of a metallic conductive material provided on the a base film of a vapor deposition film between the support layer and the thermoplastic innermost layer. Since the conductive layer has electric conductivity, application of high-frequency current to an external coil generates induction current by high-frequency induction in the conductive layer, and the heat resulting from the resistor melts the adjacent innermost plastic (thermoplastic material/resin) to seal. That is, in this invention, the conductive layer is inductively heated by high-frequency induction heating when forming the container, the generated heat is conducted to the innermost layer, and the thermoplastic innermost layer is heated to be melted or softened, and in the heated region, a heat seal region is made.

For the preferred embodiment of the invention, the conductive layer is a metal vapor deposition layer made of a metallic conductive material provided inside of a base film of a vapor deposition film between the support layer and the thermoplastic innermost layer. In the embodiment, a vapor deposition tape can be used, which is obtained by vacuum-depositing a metal such as a metallic aluminum or an aluminum alloy, to outside of the base film such as a polyethylene or a polyester. A way of metal deposition and thickness of the vapor deposition layer can be determined by various methods, e.g. a vacuum vapor deposition method, a spattering method, a plasma treatment method or the like. In the embodiment, the layer constitution of the web-shaped laminate material for a package container consists of, starting from the outside to the inside, the support layer, the vapor deposition film (the base film, the metal vapor deposition layer), and the thermoplastic innermost layer. In the embodiment, the metal vapor deposition layer is provided inside. The advantage of the embodiment is that the vapor deposition film can be provided not only in the region to be heat-sealed by high-frequency induction heating for producing the container but also over the substantially entire surface of the laminate material. Consequently, the conductive layer and the barrier layer can be simultaneously formed by laminating a vapor deposition film instead of the conventional aluminum foil laminate, in the manufacturing processes of the laminate material.

For the preferred embodiment of the invention, the conductive layer is a metal vapor deposition layer made of a metallic conductive material provided outside of a base film of a vapor deposition film between the support layer and the thermoplastic innermost layer. In the embodiment, the layer constitution of the web-shaped laminate material for a package container consists of, starting from the outside to the inside, the support layer, the vapor deposition film (the metal vapor deposition layer, the base film), and the thermoplastic innermost layer. In the embodiment, the metal vapor deposition layer is provided outside of the vapor deposition film. The advantage of the embodiment is that the vapor deposition film can be provided not only in the region to be heat-sealed by high-frequency induction heating for producing the container but also over the substantially entire surface of the laminate material, as well as the embodiment mentioned above. Consequently, the conductive layer and the barrier layer can be simultaneously formed by laminating a vapor deposition film in manufacturing the laminate material.

Further, a white masking agent is added to the base film, masking the metallic color of the metal vapor deposition layer.

For the preferred embodiment of the invention, the web-shaped laminate material manufacturing method comprises: preparing a plurality of rolled materials of the support layer; sequentially drawing the web-shaped support layer from the rolled material; laminating a vapor deposition film comprising a base film and a metal vapor deposition layer made of a metallic conductive material provided inside or outside of the base film, inside the support layer including a region to be heat-sealed by high-frequency induction heating for producing the container; printing a design for the container indirectly or directly outside of the lengthy web-shaped support layer; simultaneously or sequentially forming same or different types of, one or a plurality of thermoplastic layers, outside and inside of the printed web-shaped support layer; and jointing the front end of the web-shaped support layer in the upstream with the back end of the web-shaped support layer in the downstream to form a more lengthy web-shaped support layer. As mentioned above, the advantage of the embodiment is that the vapor deposition film can be provided not only in the region to be heat-sealed by high-frequency induction heating for forminng the container but also over the substantially entire surface of the laminate material, and the conductive layer and the barrier layer can be simultaneously formed by laminating the vapor deposition film instead of the conventional aluminum foil laminate in the manufacturing processes of the laminate material.

In the laminate material heat-sealing method of this invention, the above laminate material of the invention i.e. the web-shaped laminate material comprising a support layer and a thermoplastic innermost layer is prepared, which has a conductive layer provided in the region to be heat-sealed by high-frequency induction heating for producing the container between the support layer and the thermoplastic innermost layer so that the heat generated by the induction heating is conducted to the innermost layer, wherein the conductive layer is a metal vapor deposition layer made of a metallic conductive material provided on a base film of a vapor deposition film between the support layer and the thermoplastic innermost layer. The web-shaped laminate material is usually stored and transported in the form of a roll.

For instance, the rolled web-shaped laminate material is filled into the packaging machine, drawn from the roll and transported into the packaging machine. The web-shaped laminate material being transported is shaped into a tubular shape while lowering, and longitudinally sealed in the longitudinal direction to provide a liquid tight state without leakage. In the case of sealing longitudinally by high-frequency induction heating, high-frequency induction heating forms the heat seal region.

The fluid food is filled into the laminate material tube. The heat-seal region is formed in the transverse direction of the filled tube by high-frequency induction heating, preferably below the surface of the fluid at prescribed intervals to be sealed transversely. Subsequently, the center of the seal region is cut with a cutter knife or the like to form individual containers, and when needed, folded along crease lines to shape it in the final form.

### BRIEF DESCRIPTION OF THE DRAWINGS

FIG. 1 is a section view illustrating a part of the web-shaped laminate material of one embodiment of the invention;

FIG. 2 is a plan view illustrating a part of the web-shaped laminate material of one embodiment of the invention;

FIG. 3 is a plan view illustrating the joint of the laminate material in one embodiment of the invention;

FIG. 4 is a schematic drawing illustrating the packaging machine used for the invention;

FIG. 5 is a schematic drawing illustrating the crosswise seal device in the packaging machine used for the invention.

### BEST MODE FOR CARRYING OUT THE INVENTION

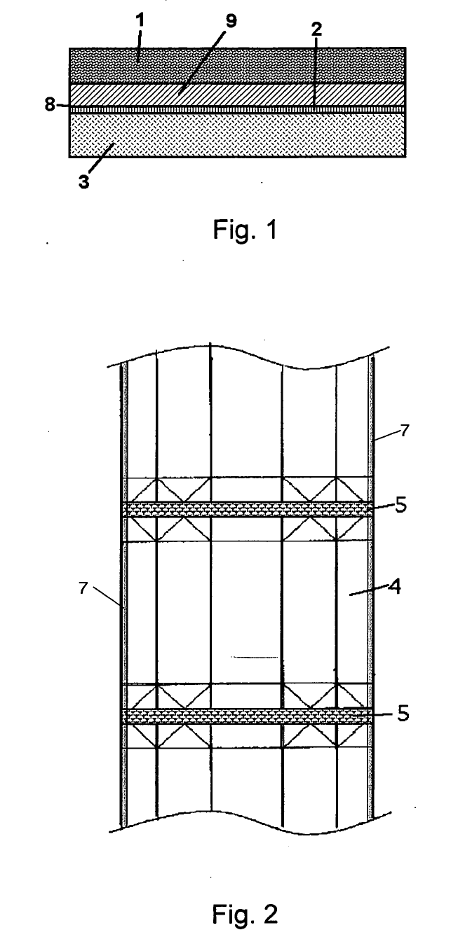

Hereinafter, embodiments of the present invention will be described using FIG. 1 to FIG. 5.

### Embodiment 1

FIG. 1 is a section view illustrating a part of the web-shaped laminate material of one embodiment of the invention. In FIG. 1, the laminate material has: a support layer (1) made of a paper, a paper board, a plastic or composite material thereof; a thermoplastic innermost layer (3) such as a low-density polyethylene or a linear low-density polyethylene; a conductive layer (2) provided in the region to be heat-sealed by high-frequency induction heating between the support layer (1) and the thermoplastic innermost layer (3) so that the heat generated by the induction heating is conducted to the innermost layer (3). The conductive layer is the metal vapor deposition layer (2) made of the metallic conductive material provided outside of the base film (9) of the vapor deposition film (8) between the support layer and the thermoplastic innermost layer.

FIG. 2 is a plan view illustrating a part of the web-shaped laminate material of one embodiment of the invention. In FIG. 2, a band-shaped laminate material (4) is a laminate material comprising a support layer made of a paper, a plastic or composite material thereof, and a thermoplastic layer such as a low-density polyethylene. A number of package containers can be obtained from the laminate material. A portion between two seal regions (5) to be transversely sealed in the transverse direction corresponds to one package container. The conductive layer is provided in the region (5) to be heat-sealed by high-frequency induction heating between the support layer and the thermoplastic innermost layer so that the heat generated by the induction heating is conducted to the innermost layer. In the case of longitudinal sealing by high-frequency induction heating, the conductive layer is also laiminated to both ends (7) in the web-shaped laminate material to form the heat seal region by high-frequency induction heating. The conductive layer is provided to the region (5) shown in FIG. 2 and its vicinity, and in the case of longitudinal sealing by high-frequency induction heating, to the both ends (7) and (7).

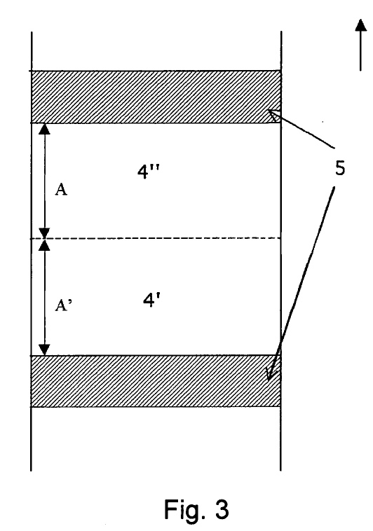

FIG. 3 is a plan view illustrating the state of jointing the final end of the laminate material (4″) from the first roll with the front end of the laminate material (4′) from the second roll. The seal region is accurately cut at the midle between the seal regions (5) of the laminate material (4″) and the seal regions (5) of the laminate material (4′). As shown in FIG. 3, the final end of the laminate material web (4″) in the downstream of printing processes and the front end of the laminate material web (4′) in the upstream of printing processes are cut so that a distance A and a distance A′ are equal in length, and the both cut surfaces of them are jointed in a temporarily stationary state. The width of the conductive layer may be taken more larger than a necessary width for acquiring a sealing property, to provide a margin capable of absorbing expansion and contraction of paper. The jointing can be accurately processed in a fast-working printer using an automatic joining device and conducted by a large-scale flexographic press or photogravure printing machine at the mass production level.

As mentioned above, the front end of the web-shaped support layer in the upstream and the back end of the web-shaped support layer in the downstream are jointed to form a more lengthy web-shaped support layer. The obtained web can be stored in the form of a roll, and can be also continuously fed in the downstream processes without storage.

The web is indirectly or directly printed with design for the container outside of the web-shaped support layer in printing processes, wherein “indirectly or directly” means that a plastic laminate layer, a film layer, a adhesive layer, an anchor coat layer or the like may be also provided between the print layer for pictures or designs and the surface of the support layer. The same or different types of, one or a plurality of thermoplastic layers are simultaneously or sequentially formed in the outside or inside of the printed web-shaped support layer, giving the single or multiple, outermost and innermost layers. In the midway process when needed, lines for facilitating puncture for a straw or formation of the container (fold lines and crease lines) are provided to the laminate material.

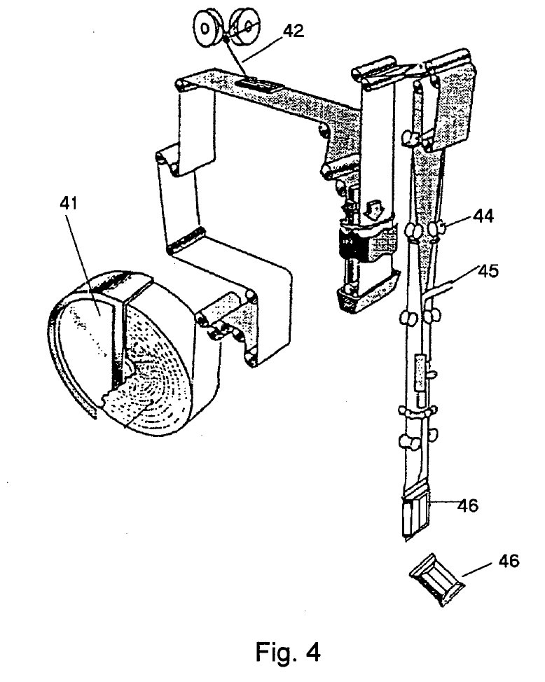

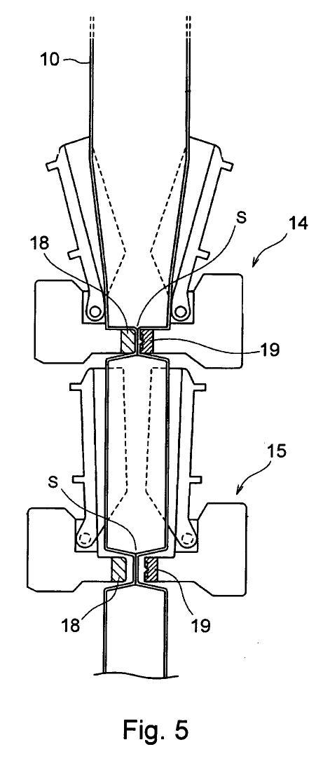

The laminate material heat-sealing method of one embodiment of the invention will be described with reference to FIG. 4 and FIG. 5.

FIG. 4 is a schematic drawing illustrating the packaging and filling machine used for the invention. The laminate material of the invention, that is, a web-shaped laminate material comprising a support layer, a vapor deposition film (a metal vapor deposition layer, a base film), and a thermoplastic innermost layer, is prepared. A rolled web-shaped laminate material (41) is filled into the packaging and filling machine, drawn from the roll (41), and transported into the filling machine. The web-shaped laminate material being transported, is adhered with a strip tape for longitudinal sealing by an applicator (42), and then shaped into a tubular shape while lowering by roller (44), and sealed in the longitudinal direction to provide a liquid tight state with no liquid leakage. When the strip tape for longitudinal sealing is jointed to one end of the laminate material by high-frequency induction heating, the conductive layer is also provided to the end (7). Additionally, in the case of longitudinal sealing by high-frequency induction heating, the conductive layer is provided to the both ends (7) and (7) of the laminate material web to form the heat seal region by high-frequency induction heating. The fluid food is supplied into the laminate material tube from a filling pipe (45). The heat-seal region is formed by high-frequency induction heating in the transverse direction of the filled tube, below the surface of the fluid at prescribed intervals to seal it transversely with a transverse sealing device (shown in FIG. 5). Subsequently, the center of each seal region mentioned above is cut with a cutter knife or the like to form individual containers (46), and when needed, folded along crease lines to shape it in the final form.

FIG. 5 is a schematic drawing illustrating the transverse sealing device in the filling machine.

As shown in FIG. 5, two transverse sealing devices (14) and (15) moving up and down, press the filled laminate material tube (10) in the transverse direction by inductors for the high-frequency induction heating (19) and counter jaws (18), and heat and cool it, then the heat-seal region (S) is fomed by high-frequency induction heating at prescribed intervals, to seal it transversely. Subsequently, the center of the seal region (S) is cut with a cutter knife or the like (not shown) to form individual containers.

In addition to the shape of the containers of the above mentioned embodiments, package containers in the invention include a brick-shaped container (parallelepipedon), a hexagonal cylinder-shaped container, an octagonal cylinder-shaped container, a tetrahedron-shaped container, a roof-shaped container and the like.

Thus, according to the present invention, the following favorable effects can be obtained.

Even if an aseptic packaging system and a chilled packaging system are installed, a part of the counter system can be diverted, thereby enabling efficient operation of the whole packaging systems, and the energy, materials and manufacturing cost can be therefore reduced.

The present invention enables seal/joint with the novel sealing method. The joint can be accurately processed in a fast-working printer using an automatic joining device and conducted by a large-scale flexographic press or photogravure printing machine at the mass production level. In the method of the present invention, the quick and definite sealing method can be applied to an inexpensive package material without any metallic foil layers.

### INDUSTRIAL APPLICABILITY

The laminate material, the laminate material manufacturing method, the laminate material heat-sealing method, and the package container in the present invention are utilized for package containers containing fluid foods like milk or soft drink etc.

1. A web-shaped laminate material for a package container comprising at least a support layer and a thermoplastic innermost layer, having a conductive layer provided in a region to be heat-sealed by high-frequency induction heating for producing the container between the support layer and the thermoplastic innermost layer so that the heat generated by the induction heating is conducted to the innermost layer, wherein the conductive layer is a metal vapor deposition layer made of a metallic conductive material provided on a base film of a vapor deposition film between the support layer and the thermoplastic innermost layer.

2. The laminate material according to claim 1, wherein said conductive layer is a metal vapor deposition layer made of a metallic conductive material provided inside of a base film of a vapor deposition film between the support layer and the thermoplastic innermost layer.

3. The laminate material according to claim 1, wherein said conductive layer is a metal vapor deposition layer made of a metallic conductive material provided outside of a base film of the vapor deposition film between the support layer and the thermoplastic innermost layer.

4. A web-shaped laminate material manufacturing method for a package container comprising at least a support layer and a thermoplastic innermost layer, comprising:
preparing a plurality of rolled materials of the support layer;
sequentially drawing the web-shaped support layer from the rolled materials;
providing a vapor deposition film comprising a base film and a metal vapor deposition layer made of a metallic conductive material provided inside or outside of the base film, inside the support layer including the region to be heat-sealed by high-frequency induction heating for producing the container;
printing a design for the container indirectly or directly outside of the lengthy web-shaped support layer;
simultaneously or sequentially forming same or different types of, one or a plurality of thermoplastic layers, outside and inside of the printed web-shaped support layer; and
jointing the front end of the web-shaped support layer in the upstream with the back end of the web-shaped support layer in the downstream to form a more lengthy web-shaped support layer.

5. A heat-sealing method of a laminate material for a package container comprising at least a
support layer and a thermoplastic innermost layer, having a conductive layer provided in the region to be heat-sealed by high-frequency induction heating for producing the container between the support layer and the thermoplastic innermost layer so that the heat generated by the induction heating is conducted to the innermost layer, comprising:
preparing a web-shaped laminate material wherein said conductive layer is a metal vapor deposition layer made of a metallic conductive material provided on a base film of a vapor deposition film between the support layer and the thermoplastic innermost layer;
shaping the web-shaped laminate material into a tubular shape to longitudinally seal the same in the longitudinal direction;
filling a fluid food into the tube of the laminate material;
forming the heat-seal region in the transverse direction of the filled tube by high-frequency induction heating at prescribed intervals to seal the same transversely; and
cutting the center of the seal region to form individual containers.

6. A package container made of a laminate material comprising at least a support layer and a thermoplastic innermost layer, having a conductive layer that is a metal vapor deposition layer made of a metallic conductive material provided on a base film of a vapor deposition film between the support layer and the thermoplastic innermost layer in the region heat-sealed by high-frequency induction heating for producing the container,
wherein the innermost layer is melted or softened by the heat generated by the induction heating to form a seal region with the softened or melted counter innermost layer.
